(19) United States
(12) Patent Application Publication
(10) Pub. No.: US 2015/0292486 A1
(43) Pub. Date: Oct. 15, 2015

(54) WIND TURBINE BLADE ICE ACCRETION DETECTOR

(71) Applicant: VESTAS WIND SYSTEMS A/S, Aarhus N (DK)

(72) Inventors: Yu Zhou, Singapore (SG); Pey Yen Siew, Lubeck (DE); Anil Sabannavar, Singapore (SG); Carsten Krogh Nielsen, Hammel (DK)

(21) Appl. No.: 14/366,617

(22) PCT Filed: Dec. 19, 2012
(86) PCT No.: PCT/DK2012/050478

§ 371 Date: Jun. 18, 2014

Related U.S. Application Data
(60) Provisional application No. 61/579,660, filed on Dec. 23, 2011.

(30) Foreign Application Priority Data
Dec. 22, 2011 (DK) PA 2011 70748

(51) Int. Cl. F03D 11/00

(52) U.S. Cl. CPC F03D 11/0025

(57) ABSTRACT

A wind turbine blade ice accretion detector 65 is configured to receive an indication of power generated by a wind turbine 67 and an indication of a plurality of environmental conditions of the wind turbine 69. It is also configured to receive an indication of an error relating to the operation of the wind turbine 71. These indications are processed by the detector 65 to provide an indication of ice accretion of a wind turbine blade. In addition to or as an alternative, the wind turbine blade ice accretion detector 65 is configured to receive an indication of power generated by a wind turbine 67 in a plurality of different time periods and an indication of a plurality of environmental conditions of the wind turbine 69 in the plurality of different time periods; and to process these to provide an indication of ice accretion of a wind turbine blade.

The invention relates to a wind turbine blade ice accretion detector and a method of detecting ice accretion on at least one wind turbine blade. A typical wind turbine to which the detector and method are suitable is for use in large scale electricity generation on a wind farm, for example.

### BACKGROUND OF THE INVENTION

FIG. 1 illustrates a typical known wind turbine 1 for use in large scale electricity generation on a wind farm. The wind turbine comprises a wind turbine tower 2 on which a wind turbine nacelle 3 is mounted. A wind turbine rotor 4 comprising a plurality of blades 5 is mounted on a hub 6. The hub is connected to the nacelle through a low speed shaft (not shown) extending from the nacelle front.

In normal use in cold climates, ice can accumulate on the wind turbine blades under particular climate conditions, which can cause a number of problems. The power producing performance of the wind turbine may be adversely affected as the ice can affect the aerodynamics of the blades and the rotating mass of the rotor. Fragments of ice can be flung from the rotating blades, in use, and this can be extremely hazardous.

Prompt or early detection of ice accretion is clearly highly beneficial so appropriate action can be taken in response to it to remove the ice to prevent these problems. For example, to stop rotation of the rotor of the wind turbine to prevent ice being flung from the blade or to switch on ice removing equipment, such as heaters, to controllably remove ice or prevent it building-up. Thus, with early ice accretion detection, wind turbine running risk is reduced and wind turbine power production improved. It is desirable, though, that false detection of ice accretion is minimised. This is because the measures taken to remove the problems caused by ice effectively reduce the amount of power generated by the wind turbine.

It is known to detect ice accretion by detecting ice falling from a wind turbine blade. One method of doing this is to detect an unbalanced rotor, which results when ice formed on a wind turbine blade falls off. However, by the time ice falls from a wind turbine blade, a significant hazard has already been caused.

Furthermore, such arrangements either use acceleration sensors or strain gauge sensors to detect ice accretion. These sensors are highly location sensitive. Therefore, a large number of these sensors are required to detect ice accretion in different locations across a wind turbine blade, which is expensive (and tedious).

Early detection is difficult because the early detrimental effects of ice accretion on the wind turbine blade are small and can be within the normal variations of the operating characteristics of the wind turbine. The system of international patent application No. WO2004/104412 aims to address this problem. It describes a method of detecting ice accretion on rotor blades of a wind power installation. In the method, detected values of operating parameters such as power produced with wind speed are compared to stored values, which are a function of measured outside temperature. The operation of the wind turbine is modified (for example, the rotation of the rotor is stopped) as a result of this comparison or the stored values of the operating parameters are modified to improve the reliability of ice detection to take into account the characteristics of a particular wind turbine to try to reduce false indications of ice accretion.

The article “Performance losses due to ice accretion for a 5 MW wind turbine”, Matthew C. Homola, Muhammad S. Virk, Per J. Nicklasson and Per A. Sundsbø, 2 Jun. 2011 | DOI: 10.1002/we.477, Wind Energy by John Wiley & Sons, Ltd discloses a study of power performance losses due to ice accretion on a large horizontal axis wind turbine blade that has been carried out using computational fluid dynamics (CFD) and blade element momentum (BEM) calculations for rime ice conditions. The article suggests changing the turbine controller to improve power production with iced blades, but this involves using a complex CFD model to estimate performance losses.

### SUMMARY OF THE INVENTION

Embodiments of the invention described herein detect ice accretion on at least one wind turbine blade robustly and accurately without requiring additional sensors to those usually provided on a wind turbine blade specifically for detecting ice on the blade. Embodiments of the invention described herein use meteorological data and power curve information to detect ice accretion. Embodiments of the invention described herein use an algorithm and methodology to detect ice accretion with high probability through existing information and standard sensors. This is achieved, by way of example, by using a power performance curve generated periodically, such as every 5 minutes, input from the wind turbine supervisory control and data acquisition system (SCADA) and environmental sensor data, turbine operation parameters along with data from various error databases, for example, error logs, alarms, and stop conditions. In this example, when the performance of the turbine falls in a consecutive number of periods more than a predefined amount and particular indications are given by environmental parameters or conditions information, turbine parameter configurations, and an error database, an ice accretion alarm flag is raised. Such alarms or alarm flags may be used for various purposes such as activating de-icing actions, wind turbine controls or to stop the wind turbine, such as by stopping rotation of the rotor. This arrangement helps to avoid unnecessarily stopping the wind turbine; it provides a high probability of accurate ice accretion detection on one or more of the wind turbine blades through data provided from standard sensors usually installed on a wind turbine.

The invention in its various aspects is defined in the independent claims below to which reference should now be made. Advantageous features are defined in the dependent claims below.

A preferred embodiment of the invention is described in more detail below and takes the form of a wind turbine blade ice accretion detector configured to receive an indication of power generated by a wind turbine and an indication of a plurality of environmental conditions of the wind turbine. It is also configured to receive an indication of an error relating to the operation of the wind turbine. These indications are processed by the detector to provide an indication of ice accretion of a wind turbine blade. In addition to or as an alternative, the wind turbine blade ice accretion detector is configured to receive an indication of power generated by a wind turbine in a plurality of different time periods and an indication of a plurality of environmental conditions of the wind turbine in the plurality of different time periods; and to process these to provide an indication of ice accretion of a wind turbine blade.

In an aspect of the present invention, there is provided a method of detecting ice accretion on at least one wind turbine blade, the method comprising: measuring power generated by a wind turbine; measuring a plurality of environmental conditions of the wind turbine; checking for an error relating to operation of the wind turbine; and indicating ice accretion on at least one wind turbine blade depending on the measured power generated, the measured plurality of environmental conditions, and an error as a result of the checking.

In a further aspect of the present invention, a method of detecting ice accretion on at least one wind turbine blade, the method comprising: measuring in a plurality of different time periods power generated by a wind turbine and a plurality of environmental conditions of the wind turbine; and indicating ice accretion on at least one wind turbine blade depending on the measured power generated and measured plurality of environmental conditions in the plurality of different time periods.

In a yet further aspect of the present invention, there is provided a wind turbine blade ice accretion detector configured to: receive an indication of power generated by a wind turbine; receive an indication of a plurality of environmental conditions of the wind turbine; receive an indication of an error relating to the operation of the wind turbine; and provide an indication of ice accretion of a wind turbine blade depending on the indication of power generated, the indication of the plurality of environmental conditions and the indication of an error.

In a still further aspect of the present inventions, there is provided a wind turbine blade ice accretion detector configured to: receive an indication of power generated by a wind turbine in a plurality of different time periods and an indication of a plurality of environmental conditions of the wind turbine in the plurality of different time periods; and provide an indication of ice accretion of a wind turbine blade depending on the indication of power generated in the plurality of different time periods and the indication of a a plurality of environmental conditions in the plurality of different time periods.

All of these aspects of the invention accurately detect ice accretion on at least one wind turbine blade using sensors typically provided on a wind turbine.

### BRIEF DESCRIPTION OF THE DRAWINGS

Preferred embodiments of the invention will now be described, by way of example, and with reference to the drawings in which:

FIG. 1 is a front view of a known wind turbine;

FIG. 1A is a schematic view of a wind turbine blade ice accretion detector embodying an aspect of the present invention;

FIG. 2 is a schematic view of a method carried out by the wind turbine blade ice accretion detector of FIG. 1A;

FIG. 3 is a graph of delta power against time for a wind turbine including the wind turbine blade ice accretion detector of FIG. 1A;

FIG. 4 is a graph of wind turbine generated power against wind speed;

FIG. 5 is another graph of wind turbine generated power against wind speed;

FIG. 6 is another graph of wind turbine generated power against wind speed;

FIG. 7 is a series of graphs of various parameters related to power measurement of a wind turbine against time;

FIG. 8 is a series of graphs of various environmental parameters to which a wind turbine is exposed against time; and

FIG. 9 is a flow diagram of a method carried out by the wind turbine blade ice accretion detector of FIG. 1A.

### DETAILED DESCRIPTION OF PREFERRED EMBODIMENTS

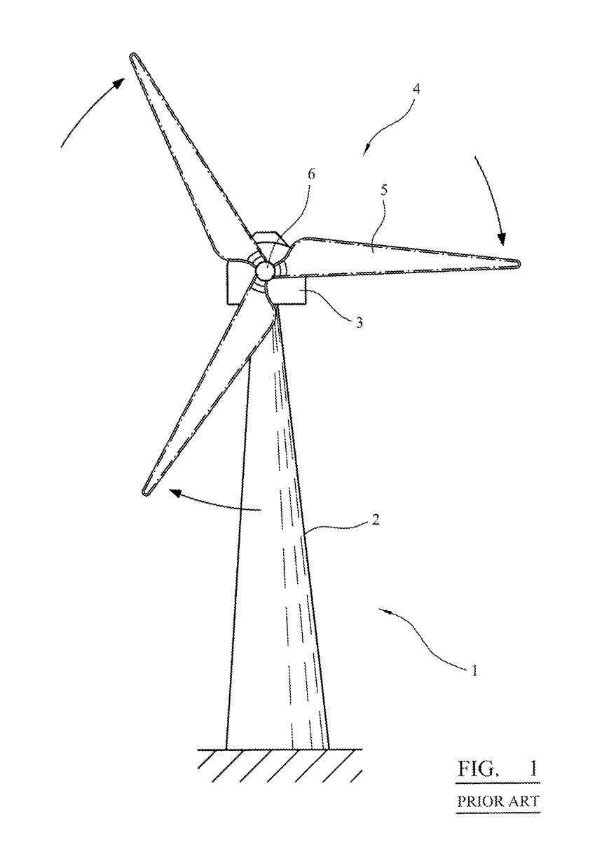

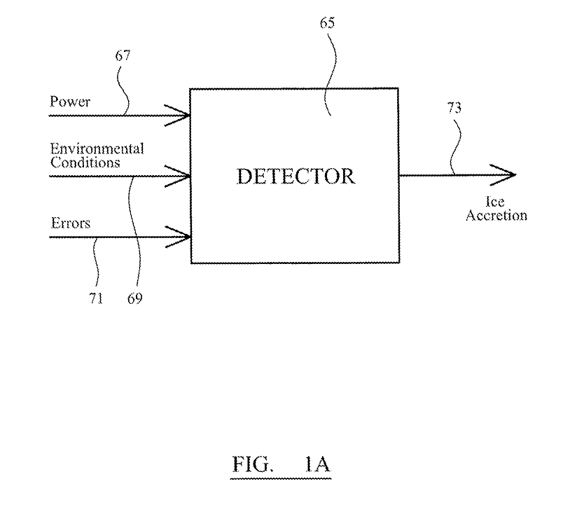

A schematic view of a wind turbine blade ice accretion detector 65 is illustrated in FIG. 1A. It may be implemented on a small model of wind turbine intended for domestic or light utility usage, but it is intended primarily for use on a large model of wind turbine, such as those that are suitable for use in large scale electricity generation on a wind farm for example. In which case, the diameter of the rotor could be as large as 100 metres or more. The wind turbine blade ice accretion detector is configured to receive indications in the form of electrical signals from the wind turbine in which it is housed of: power generated by a wind turbine 67; environmental conditions of the wind turbine 69; and errors relating to the wind turbine 71. It processes these indications or information as described in more detail below to provide an indication, in the form of electrical signals, of ice accretion of a wind turbine blade. This indication is output from an output 73.

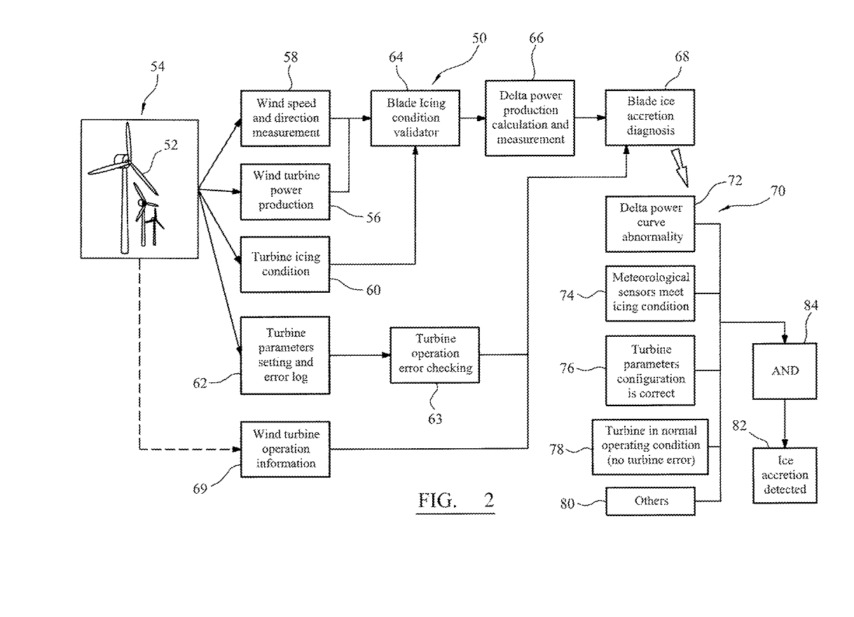

FIG. 2 illustrates a general overview 50 of the method implemented by the wind turbine blade ice accretion detector 67 of FIG. 1A.

Generally, the method of detecting ice accretion on wind turbine blades 52 includes collecting and processing various specific data related to a wind turbine's 54 operation and environmental conditions. In a blade ice accretion diagnosis, these factors are compared against particular thresholds and an indication of detection of ice accretion is given depending on these data if these thresholds are exceeded.

In more detail, power generated or produced 56 by a wind turbine 54 and the wind speed and direction 58 of the wind to which the wind turbine is exposed are measured. Other environmental conditions or turbine icing conditions 60 to which the wind turbine is exposed are also measured. These are factors that are typically present for ice to be expected, such as ambient temperature, as well as visibility, precipitation level, and dew point. The inventors have appreciated that these latter factors are the most important to make a particularly accurate prediction of ice accretion. The wind turbine parameters setting and error log 62 is also interrogated or checked and turbine operation error checking is also made 63.

The power produced 56, wind speed and direction 58, and turbine icing condition information 60 are entered into a blade icing validator 64. This information is used to adjust or normalise the measured power generated to substantially exclude the influence of wind speed by producing a so-called delta power curve in a delta power production calculation and measurement system 66. Wind direction can also be considered. In which case, a different delta power curve is derived for different wind directions.

The delta power curve is derived in the delta power production calculation and measurement system 66 by calculating the difference between the measured normalised power curve Pₘₑₐₛ with the reference design power P_{ref}. This is carried out using equation (1):

ΔP=Pₘₑₐₛ−P_{ref}=C×d×(Vₘₑₐₛ×(Tₘₑₐₛ/293.15)^{-1/3})³−P_{ref} (1)

where C is the aerodynamic constant (a constant for a particular wind turbine that depends on wind turbine characteristics and mainly on particular wind turbine design or model, but also aspects of the installation of the particular wind turbine, such as location and blade position),
d is air density,
Vₘₑₐₛ is wind velocity (at the nacelle), and
Tₘₑₐₛ is ambient temperature.

The result of this calculation is entered into a blade ice accretion diagnosis arrangement 68 together with errors relating to the wind turbine (this is by checking for errors contemporaneously via turbine operation error checking 63 and by interrogating a store for errors from past checks stored in the turbine parameters setting and error log 62) as well as wind turbine operation information 69 including, for example, whether the wind turbine is producing no power (stop condition), producing power but not contributing to the grid or distribution system, or rotation of the rotor is stopped for some other reason.

The blade ice accretion diagnosis arrangement 68 carries out a number of checks or comparisons 70 to various thresholds to ascertain whether ice accretion is detected. These include the following. Comparing the power measurement or delta power curve to a predetermined power threshold and, if this threshold is violated, a delta power curve abnormality 72 is indicated or flagged. Comparing environmental conditions to a predetermined environmental condition threshold and, if this threshold is violated, an indication or flag 74 is raised. The result of the error checking by checking for wind turbine operation errors contemporaneously via turbine operation error checking or turbine parameters configuration checking 76 and by interrogating a store for errors from past checks stored in the turbine parameters setting and error log 78 are compared to a predetermined error threshold and, if this threshold is violated, an indication or flag is raised. Other measurements or checks of other parameters or conditions may also be made 80 and compared to other thresholds and a corresponding flag raised or indication made if this threshold is violated. If all of the comparisons 70 above result in a flag being raised, ice accretion is detected 82 and an appropriate indication is made or flag raised so appropriate action can be taken, for example, switching on heaters in the wind turbine blades. In practice, a flag raised is an electrical signal carrying an indication in the form of a bit (or group of bits) in a particular position in a data stream set to a particular value, for example, a 1. Thus, if all of the comparisons 70 above result in a flag being raised logically ANDing these flags 84 result in an output of 1, which indicates that ice accretion is detected 82.

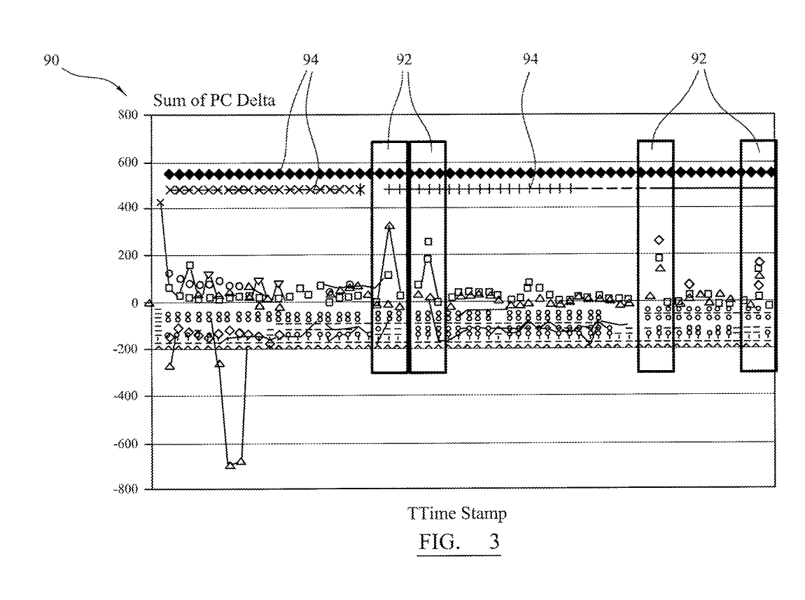

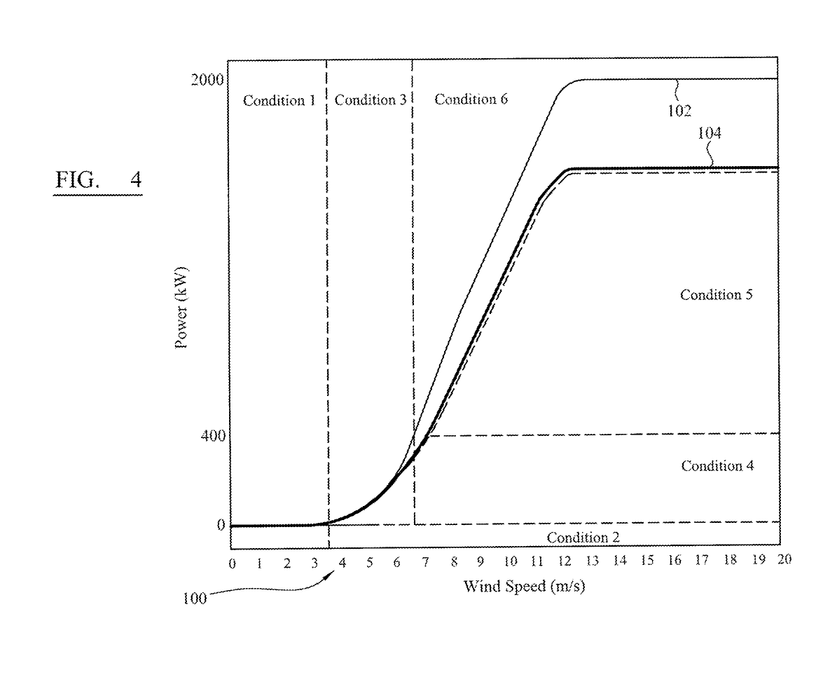

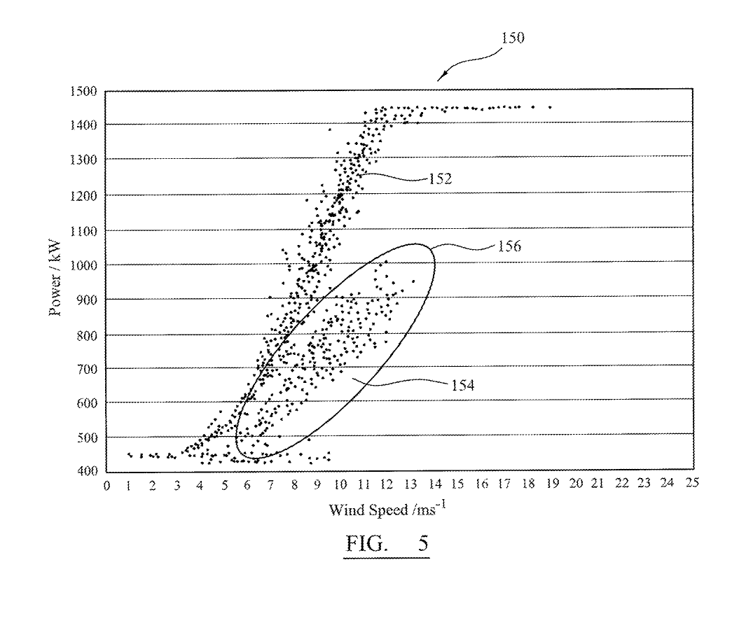

FIG. 3 is a graph 90 of ΔP (delta power) against time for a wind turbine in use. Under normal conditions, ΔP can be expected to be around zero. A value of ΔP significantly greater than zero indicates a possibility of ice accretion on one or more wind turbine blade. Thus, the time periods where ΔP is significantly greater than zero highlighted by rectangles 92 in FIG. 3 indicate a possibility of ice accretion on the wind turbine blades. The samples where ΔP is constantly above zero indicated by reference numeral 94 is where the wind turbine rotor is stopped and thus no power is generated. This type of condition is factored in by the arrangement described herein to reduce the likelihood of a false indication of ice accretion being made. This is discussed below with reference to FIG. 4.

FIG. 4 is a graph 100 of average power generated by a wind turbine versus wind speed. It illustrates the various conditions of operation of a wind turbine and which ones indicate a high probability of ice accretion.

The expected power (upper line) 102 is the best fit curve from the measured wind speed and power of a typical wind turbine, for example a Vestas V90-2 MW of standard design. Performance of the method described herein is improved if this curve is normalised or fine tuned to take into account particular characteristics of the built or commissioned wind turbine. The threshold line 104 (the continuous line directly below the expected power line 102) represents 80% of the expected power (fine tuned to suit the algorithm). This is where power production is expected not be less than, in normal use, during power generation with delivery to the grid, with the given wind speed at any given time if there is no ice accretion on the blades.

Six operating conditions are illustrated in FIG. 4. Separation between operating conditions is illustrated by a dashed line. Condition 1 is where the wind speed is less than 3.5 m/s and the wind turbine is not producing any power (stop condition). Condition 2 is where the wind speed is greater than or equal to 3.5 m/s but the wind turbine is stopped due to another reason. Condition 3 is where the wind speed is greater than or equal to 3.5 m/s, but less than 6.5 m/s, and the wind turbine is producing power but not contributing to the grid. Condition 4 is where wind speed is greater then or equal to 6.5 m/s and the power production is less than threshold and less than 400 kW (this is a so-called “under perform” area). Condition 5 is where wind speed is greater than or equal to 6.5 m/s and the power production is less than the threshold and greater than or equal to 400 kW (this is another so-called “under perform” area). Condition 6 is where wind speed is greater than or equal to 6.5 m/s and the wind turbine is producing power and contributing to the grid as expected.

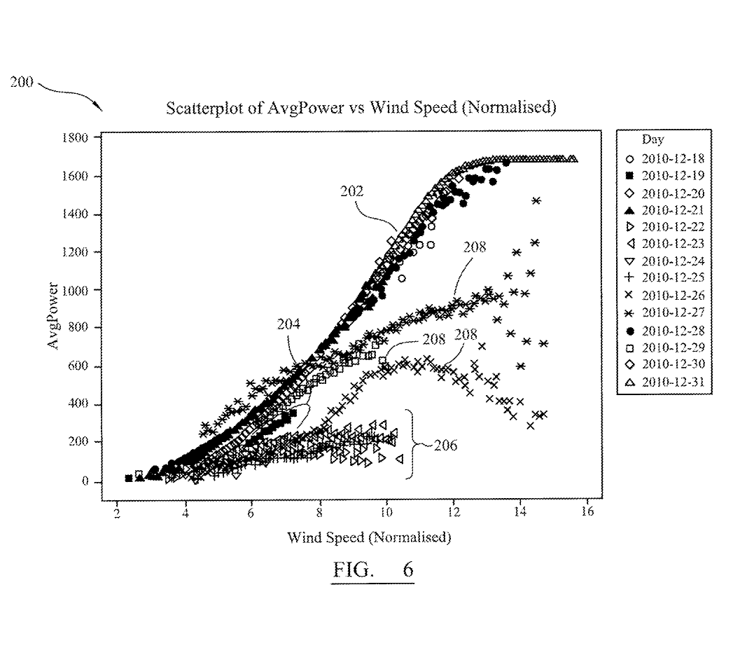

FIG. 5 is a graph 150 of average power generated by a wind turbine versus normalised wind speed. The upper curve 152 showing greater power produced for a given wind speed is an actual power curve which shows that the wind turbine is running as expected. The lower curve 154 (highlighted by an oval 156) showing less power produced for a given wind speed is an actual power curve which shows that the turbine is running in the “under perform” area. This case shows a high probability of ice accretion of at least one wind turbine blade when noted together with the environmental conditions.

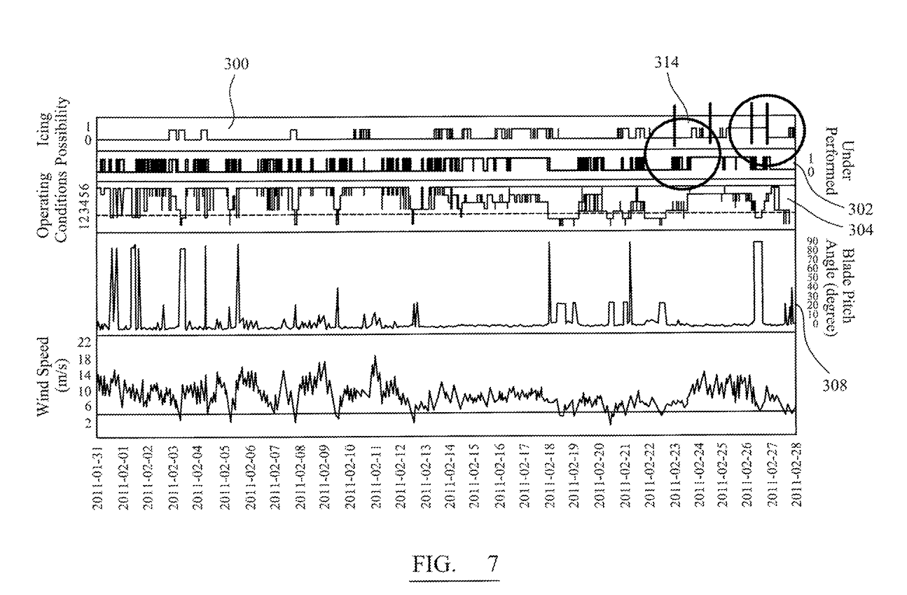

The graph 200 of FIG. 6 also shows average power generated by a wind turbine versus normalised wind speed. It is a more complex example with each different symbol representing a sample points on a different day. The days are consecutive days during a winter period when ice accretion might be reasonably expected. During these different days, the wind turbine operates under different conditions of the six types described above. In some days, represented by curves 202 and 204, the wind turbine operates throughout without entering the underperforming conditions 4 and 5 indicating a possibility of ice accretion. In the days represented by curves 202, the wind turbine operates in part under condition 6 where it operates as expected and makes a contribution to the grid. In the days represented by curves 204, the wind turbine operates only ever under conditions 1 and 3 so it is either not producing any power or producing power, but not contributing to the grid. In some days, represented by curves 206 and 208, the wind turbine operates at some time by entering the underperforming conditions 4 and 5 indicating a possibility of ice accretion. In the days represented by curves 206, the wind turbine operates under condition 4 for a significant period where it underperforms and produces less than 400 kW of power. In the days represented by curves 208, the wind turbine operates under condition 5 for a significant period where it underperforms, but produces more than or equal to 400 kW of power.

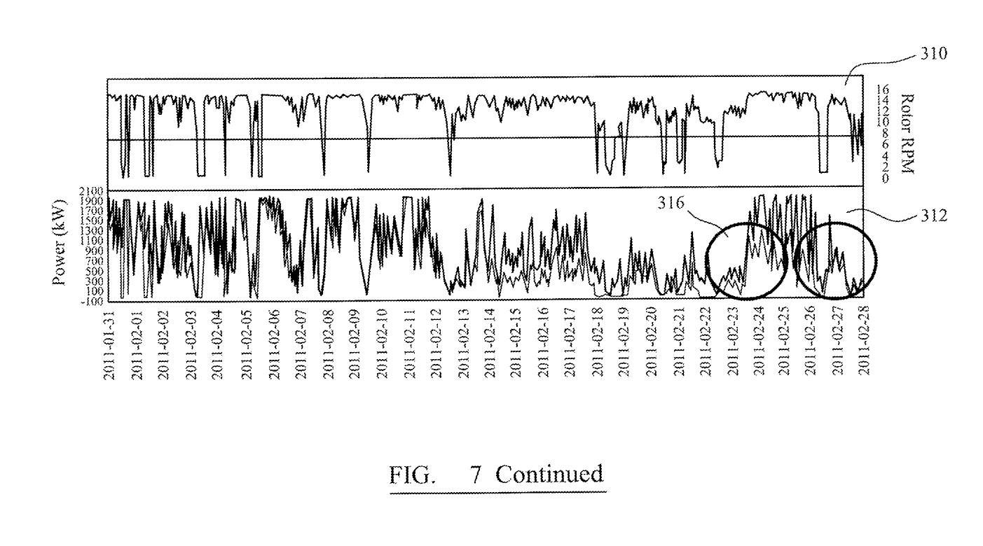

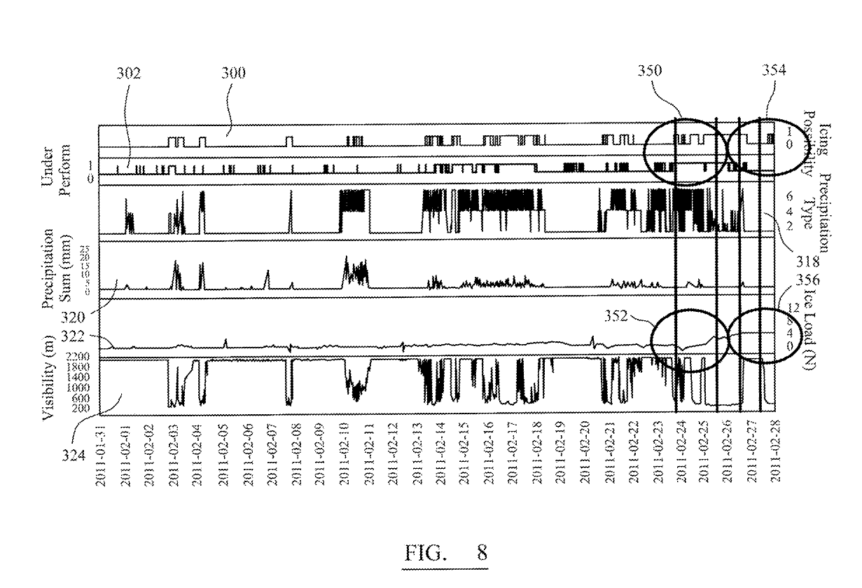

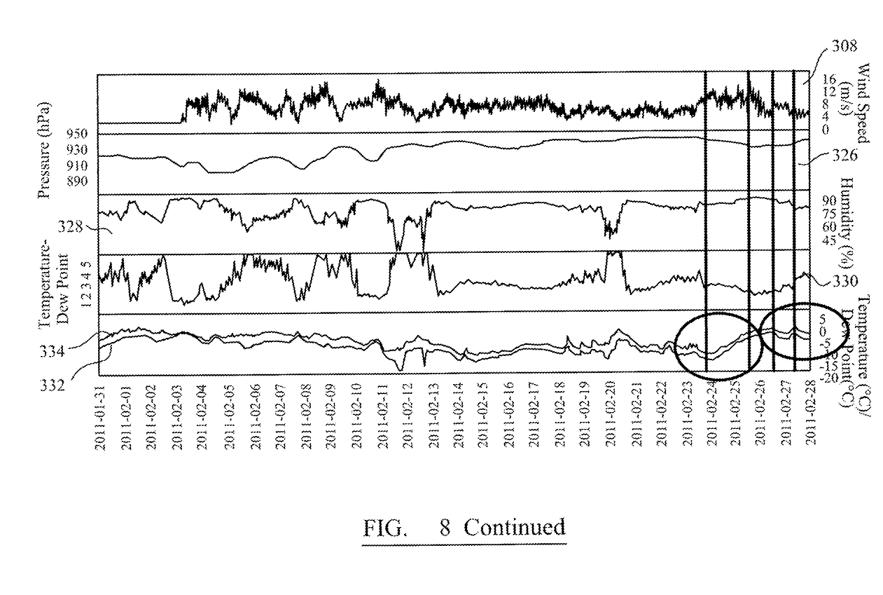

FIG. 7 shows a series of graphs of various parameters related to power measurement of the wind turbine against time. They are icing possibility 300, underperformance condition 302, operating condition 304, blade pitch 306, wind speed 308, rotor rotational speed 310, and power produced 312. Area 316 shown by an oval highlights a period where the actual power produced is less than the expected power. Indeed, as highlighted by area 316 shown by an oval, the underperformance condition is shown as generated from the underperformance algorithm curve of FIG. 4. Thus, an indication is given that there is the possibility of ice accretion from this information. However, the certainty of ice accretion is enhanced by some of the series of graphs shown in FIG. 8, which shows various environmental parameters or conditions to which the wind turbine is also exposed against time. These include precipitation type 318 (a value between 0 and 6 is used in this example with each number representing a different precipitation type, including for example, no precipitation, rain, snow, or a combination of rain and snow), the sum or depth of the precipitation 320, visibility (distance) 324, air pressure 326, humidity 328, temperature—dew point 330, dew point 332 and temperature 334. Ice load 322 is also shown in FIG. 8, which is for test purposes only to verify the effectiveness of the arrangement and it is discussed further below. An ice load measurement does not form part of the arrangement in normal use.

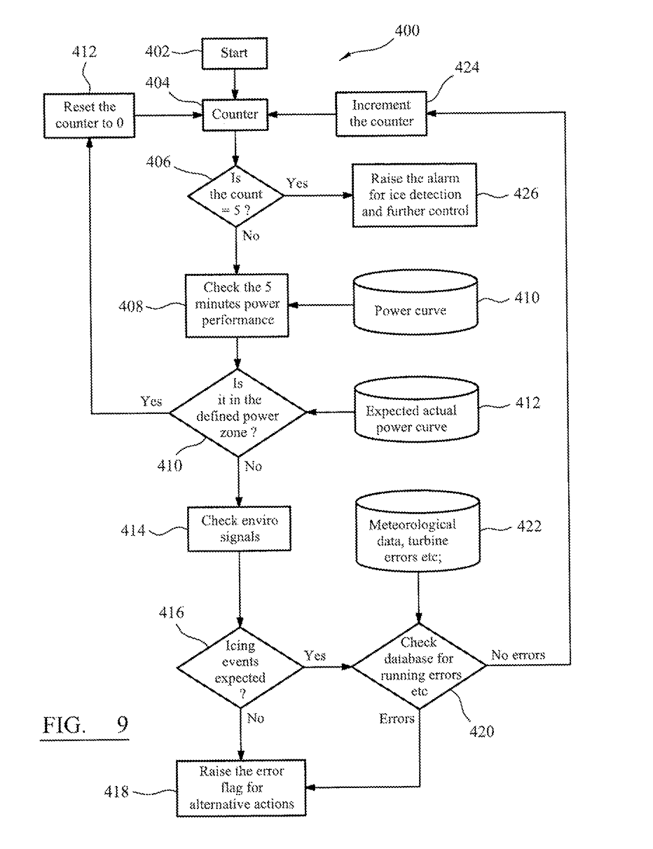

The flow diagram 400 of FIG. 9 illustrates how these various parameters are used by a detector (detector 67 of FIG. 1A) to indicate ice accretion on at least one wind turbine blade in more detail.

Periodically, the detector starts attempting to detect ice accretion on at least one wind turbine blade 402. A counter 404 checks 406 to ascertain if measurements have been made and received in a required, predetermined number of different time periods. In this example, the required number or count number is five. This number is typically, however, three or greater. If less than the predetermined number of different time periods have been checked (which is the case here as the counter has only just been started, and thus the counter is zero) then relevant data is received for the following time period, in this case, 5 minutes 408. Typically, though, the time period is between 1 and 20 minutes or between 2 and 10 minutes. In this period, an indication of power curve data is received 410. That is to say, an indication of the power generated by the wind turbine in the time period that has been adjusted to exclude the influence of wind speed and wind direction acting on the wind turbine using equation (1) set-out above. The power curve has also been normalised by taking into account the stop conditions of the individual or particular wind turbine and its own running condition after commissioning. The power curve or indication of the power curve is then compared 410 to the expected actual power curve or Granberget power curve 412 as illustrated in FIG. 4. This power curve may be based on the individual wind turbine or the mean power generated by wind turbines in a group of wind turbines including the wind turbine being tested for wind turbine blade ice accretion. If the measured power curve falls under condition 6 of the example of FIG. 4, that is to say it generates power to the grid normally, then the counter is reset to zero 412 and the process restarts from the counter at step 404. However, if the measured power curve does not fall under condition 6 of the example of FIG. 4 then at least one environmental condition is checked 414 from an indication or signals received from appropriate sensors of the wind turbine. This may include, for example, ambient temperature. If these environmental conditions are such that an icing event is not expected 416, for example, if the ambient temperature is more than 2° C. (more than 0° C. is also a possibility) then an error flag is raised or an indication of error is provided by the detector so that appropriate action may be taken 418. If these environmental conditions are such that an icing event is to be expected, for example, if the ambient temperature is more than 2° C. then other checks are run 420. These include environmental conditions including meteorological conditions, such as visibility, precipitation, dew point and humidity, as well as wind turbine operation errors 422. If one or more errors exist, then an error flag is raised or an indication of error is provided by the detector so that appropriate action may be taken 418. If there are no errors, and the predefined limits of the predefined one or more environmental conditions or meteorological conditions are breached, for example, (ambient temperature—dew point) is less than 3.5° C., relative humidity is more than 80% and visibility is less than 600 metres, then the counter is incremented 424 to indicate that measurements have been made and received in a time or sample period. The process or method then repeats with the counter 404 checking 406 to ascertain if measurements have been made and received in a required, predetermined number of different time periods. If the required number is reached (in this example, five) then an alarm is raised or indication given that ice is detected or at least probable on at least one wind turbine blade 426. Thus, an ice probability curve is generated. In other words, an indication of ice accretion of a wind turbine blade is provided depending on the indication of power generated in a plurality of different time periods.

In this example, the environmental or meteorological conditions that are checked in step 420 are slightly conservative to err on the side of caution as regards the possibility of ice formation. For example, the visibility could in practice be higher than indicated, the (ambient temperature—dew point) less than indicated, and the relative humidity higher than indicated.

Turning back to FIG. 8, the effectiveness of the arrangement is demonstrated in the regions highlighted by ovals 350, 352, 354, 356. In region 350, an icing possibility is indicated by an icing possibility of 1. At the same time, as shown in the ice load graph and highlighted by region 352, ice load increases from 0 indicating ice accretion. At a later time, highlighted by region 356, the ice load has reached a plateau (stays approximately constant) while the icing possibility highlighted by region 354 oscillates from there being a possibility (1 icing possibility) to no possibility (0 icing possibility) as indicated by the arrangement.

In summary, the ice accretion detector uses a power curve generated or delta power curve generated at, for example, every 5 minutes from the wind turbine SCADA and environmental sensor data along with various databases, such as error logs, alarms, and stop conditions. As the performance of the turbine falls consecutively more than, for example, five times in the zone or remains in the “underperforming” region where the possibility of ice is indicated (or the possibility of ice is simply indicated) and along with the environmental parameter or conditions information and other data base information, an ice accretion alarm flag is raised.

In summary, an example of another arrangement operates as follows. A measured power curve is normalised to exclude the wind speed influence on power curve variation. A delta power curve is derived by calculating the difference between the measured normalized power curve with a reference design power. Furthermore, wind speed direction is considered. That is, the delta power curve is derived for different wind directions. The delta power curve is monitored according to different wind turbine platforms and wind turbine geography location. Any deviation of the delta power curve from the group mean greater than a predefined threshold value is considered an abnormality. Upon detection of abnormality of delta power curve, the inputs from meteorological sensors are checked for ice conditions, for example, temperature less than 0° C. The system also checks the wind turbine operation condition to exclude the delta power curve abnormality being caused by wind turbine operation error or different wind turbine operation mode, for example, noise mode. As a result, a diagnosis of ice accretion on a wind turbine blade is made.

The detector may be implemented in hardware or as software as a computer program run on a computer. The computer program may be provided on a computer-readable medium such as solid state memory, a hard disk drive, a CD-ROM or a DVD-ROM.

The invention has been described with reference to example implementations, purely for the sake of illustration. The invention is not to be limited by these, as many modifications and variations would occur to the skilled person. The invention is to be understood from the claims that follow.

What is claimed is:

1. A method of detecting ice accretion on at least one wind turbine blade, the method comprising:
measuring power generated by a wind turbine;
measuring a plurality of environmental conditions of the wind turbine;
checking for an error relating to operation of the wind turbine; and
indicating ice accretion on at least one wind turbine blade depending on the measured power generated, the measured plurality of environmental conditions, and the existence of an error as a result of the checking.

2. A method according to claim 1, further comprising:
adjusting the measured power generated to substantially exclude the influence of at least one of wind speed and wind direction.

3. A method according to claim 1, further comprising:
adjusting the measured power generated to substantially exclude the influence of both wind speed and wind direction.

4. A method according to claim 3, further comprising:
adjusting the measured power generated to substantially exclude the influence of both wind speed and wind direction by deriving a delta power curve as the measured power generated based on at least one of air density, wind velocity, ambient temperature, wind turbine characteristics.

5. A method according to claim 4, wherein the delta power curve is derived as:
C×d×(Vₘₑₐₛ×(Tₘₑₐₛ/293.15)^{-1/3})³−P_{ref}
where
C is a constant for the wind turbine,
d is air density at the wind turbine,
Vₘₑₐₛ is wind velocity at the wind turbine,
Tₘₑₐₛ is ambient temperature at the wind turbine, and
P_{ref} is reference design power of the wind turbine.

6. A method according to claim 1, wherein the plurality of environmental conditions includes wind.

7. A method according to claim 6, wherein the plurality of environmental conditions includes wind speed and wind direction.

8. A method according to claim 1, wherein the plurality of environmental conditions includes at least one of: visibility, precipitation, dew point, humidity.

9. A method according to claim 1, wherein the measured power generated is compared to mean power generated by wind turbines in a group of wind turbines including said wind turbine.

10. A method of detecting ice accretion on at least one wind turbine blade, the method comprising:
measuring in a plurality of different time periods power generated by a wind turbine and a plurality of environmental conditions of the wind turbine; and
indicating ice accretion on at least one wind turbine blade depending on the measured power generated and measured plurality of environmental conditions in the plurality of different time periods.

11. A method according to claim 10, further comprising:
checking, in the plurality of different time periods, for an error relating to operation of the wind turbine; and
indicating ice accretion on at least one wind turbine blade depending on the existence of an error as a result of the checking.

12. A method according to claim 10, further comprising:
adjusting the measured power generated to substantially exclude the influence of at least one of wind speed and wind direction.

13. A method according to claim 10, further comprising:
adjusting the measured power generated to substantially exclude the influence of both wind speed and wind direction.

14. A method according to claim 13, further comprising:
adjusting the measured power generated to substantially exclude the influence of both wind speed and wind direction by deriving a delta power curve as the measured power generated based on at least one of air density, wind velocity, ambient temperature, wind turbine characteristics.

15. A method according to claim 14, wherein the delta power curve is derived as:
C×d×(Vₘₑₐₛ×(Tₘₑₐₛ/293.15)^{-1/3})³−P_{ref}
where
C is a constant for the wind turbine,
d is air density at the wind turbine,
Vₘₑₐₛ is wind velocity at the wind turbine,
Tₘₑₐₛ is ambient temperature at the wind turbine, and
P_{ref} is reference design power of the wind turbine.

16. A method according to claim 10, wherein the plurality of environmental conditions includes wind.

17. A method according to claim 16, wherein the plurality of environmental conditions includes wind speed and wind direction.

18. A method according to claim 10, wherein the plurality of environmental conditions includes at least one of: visibility, precipitation, dew point, humidity.

19. A method according to claim 10, wherein the measured power generated is compared to mean power generated by wind turbines in a group of wind turbines including said wind turbine.

20. A computer program for implementing the method of claim 1 on a computer.

21. A computer-readable medium comprising a computer program for implementing the method of claim 1 on a computer.

22. A wind turbine blade ice accretion detector configured to:
receive an indication of power generated by a wind turbine;
receive an indication of a plurality of environmental conditions of the wind turbine;
receive an indication of an error relating to the operation of the wind turbine; and
provide an indication of ice accretion of a wind turbine blade depending on the indication of power generated, the indication of the plurality of environmental conditions and the indication of an error.

23. A detector according to claim 22, further configured to:
adjust the indication of power generated to substantially exclude the influence of at least one of wind speed and wind direction.

24. A detector according to claim 22, further configured to:
adjust the indication of power generated to substantially exclude the influence of both wind speed and wind direction.

25. A detector according to claim 24, further configured to:
adjust the measured power generated to substantially exclude the influence of both wind speed and wind direction by deriving a delta power curve as the measured power generated based on at least one of air density, wind velocity, ambient temperature, wind turbine characteristics.

26. A detector according to claim 25, wherein the delta power curve is derived as:
C×d×(Vₘₑₐₛ×(Tₘₑₐₛ/293.15)^{-1/3})³−P_{ref}
where
C is a constant for the wind turbine,
d is air density at the wind turbine,
Vₘₑₐₛ is wind velocity at the wind turbine,
Tₘₑₐₛ is ambient temperature at the wind turbine, and
P_{ref} is reference design power of the wind turbine.

27. A detector according to claim 22, wherein the plurality of environmental conditions includes wind.

28. A detector according to claim 27, wherein the plurality of environmental conditions includes wind speed and wind direction.

29. A detector according to claim 22, wherein the plurality of environmental conditions includes at least one of: visibility, precipitation, dew point, humidity.

30. A detector according to claim 22, wherein the indication of power generated is compared to an indication of mean power generated by wind turbines in a group of wind turbines including said wind turbine.

31. A wind turbine blade ice accretion detector, comprising:
a receiver to receive an indication of power generated by a wind turbine in a plurality of different time periods and an indication of a plurality of environmental conditions of the wind turbine in the plurality of different time periods; and
an output element to provide an indication of ice accretion of a wind turbine blade depending on the indication of power generated in the plurality of different time periods and the indication of the plurality of environmental conditions in the plurality of different time periods.

32. A detector according to claim 31, further configured to:
receive an indication of an error relating to operation of the wind turbine in the plurality of different time periods; and
provide an indication of ice accretion of a wind turbine blade depending on the error in the plurality of different time periods.

33. A detector according to claim 31, further configured to:
adjust the indication of power generated to substantially exclude the influence of at least one of wind speed and wind direction.

34. A detector according to claim 33, further configured to:
adjust the indication of power generated to substantially exclude the influence of both wind speed and wind direction.

35. A detector according to claim 34, further configured to:
adjust the measured power generated to substantially exclude the influence of both wind speed and wind direction by deriving a delta power curve as the measured power generated based on at least one of air density, wind velocity, ambient temperature, wind turbine characteristics.

36. A detector according to claim 35, wherein the delta power curve is derived as:
C×d×(Vₘₑₐₛ×(Tₘₑₐₛ/293.15)^{-1/3})³−P_{ref}
where
C is a constant for the wind turbine,
d is air density at the wind turbine,
Vₘₑₐₛ is wind velocity at the wind turbine,
Tₘₑₐₛ is ambient temperature at the wind turbine, and
P_{ref} is reference design power of the wind turbine.

37. A detector according to claim 1, wherein the plurality of environmental conditions includes wind.

38. A detector according to claim 37, wherein the plurality of environmental conditions includes wind speed and wind direction.

39. A detector according to claim 31, wherein the plurality of environmental conditions includes at least one of: visibility, precipitation, dew point, humidity.

40. A detector according to claim 31, wherein the indication of power generated is compared to an indication of mean power generated by wind turbines in a group of wind turbines including said wind turbine.

41. A wind turbine comprising the wind turbine blade ice accretion detector of claim 22.
